(19) United States
(12) Patent Application Publication
(10) Pub. No.: US 2010/0001075 A1
(43) Pub. Date: Jan. 7, 2010

(54) MULTI-IMAGING SCANNER FOR READING IMAGES

(75) Inventor: EDWARD BARKAN, Miller Place, NY (US)

Correspondence Address: MOTOROLA, INC., 1303 EAST ALGONQUIN ROAD, IL01/3RD, SCHAUMBURG, IL, 60196, US

(73) Assignee: Symbol Technologies, Inc., Holtsville, NY (US)

(21) Appl. No.: 12/168,347

(22) Filed: Jul. 7, 2008

(51) Int. Cl. G06K 7/10

(52) U.S. Cl. 235/462.41; 235/470

(57) ABSTRACT

A multi-camera imaging-based scanner for imaging multiple target objects at substantially the same time and method is provided. The multi-camera imaging-based scanner comprises an image processing system with memory programmed to identify overlapping areas of field-of-views of the multiple cameras with in a scan field, such that if a target object is imaged by more than one camera at substantially the same time in one of the over lapping areas between two or more cameras' field-of-views, the processing system defines that a single target object has been detected and the decoded information therefrom is processed only once. If multiple target objects are imaged by more than one camera at substantially the same time outside of any of the over lapping areas between two or more cameras' field-of-views, the processing system defines that multiple target objects have been detected and the decoded information for each target object is processed.

### TECHNICAL FIELD

The present disclosure relates to a multi-imager scanner for reading multiple images.

### BACKGROUND

Various electro-optical systems have been developed and used for reading optical indicia, such as barcodes. A barcode is a coded pattern of graphical indicia comprised of a series of bars and spaces of varying widths, the bars and spaces having differing light reflecting characteristics. The pattern of the bars and spaces encode information. Barcode may be one-dimensional (e.g., UPC barcode) or two-dimensional (e.g., DataMatrix barcode). Systems that read, that is, image and decode barcodes employing imaging camera systems are typically referred to as imaging-based barcode readers.

Imaging-based barcode readers may be portable or stationary. A portable barcode reader is one that is adapted to be held in a user's hand and moved with respect to target indicia, such as a target barcode, to be read, that is, imaged and decoded. Stationary barcode readers are mounted in a fixed position, for example, relative to a point-of-sales counter often referred to as a bi-optic scanner or bi-optic imager. Target objects, e.g., a product package that includes a target barcode, are moved or swiped past one of the one or more transparent windows and thereby pass within a field-of-view (“FOV”) of the stationary barcode readers. The barcode reader typically provides an audible and/or visual signal to indicate the target barcode has been successfully imaged and decoded. Sometimes barcodes are presented, as opposed to swiped. This typically happens when the swiped barcode failed to scan, so the operator tries a second time to scan it. Alternately, presentation is done by inexperience users, such as when the reader is installed in a self-check-out installation.

A typical example where a stationary imaging-based barcode reader would be utilized includes a point of sale counter/cash register where customers pay for their purchases. The reader is typically enclosed in a housing that is installed in the counter and normally includes a vertically oriented transparent window and/or a horizontally oriented transparent window, either of which may be used for reading the target barcode affixed to the target object, i.e., the product or product packaging for the product having the target barcode imprinted or affixed to it. The sales person (or customer in the case of self-service check out) sequentially presents each target object's barcode either to the vertically oriented window or the horizontally oriented window, whichever is more convenient given the specific size and shape of the target object and the position of the barcode on the target object.

A stationary imaging-based barcode reader that has a plurality of imaging cameras can be referred to herein as a multi-camera, imaging-based scanner, barcode reader, or multi-imager scanner. In a multi-imager scanner, each camera system typically is positioned behind one of the plurality of transparent windows such that it has 3 different field-of-view from every other camera system. While the fields-of-view may overlap to some degree, the effective or total field-of-view (“TFV”) of the multi-imaging scanner is increased by adding additional camera systems. Hence, the desirability of multi-camera readers as compared to signal camera readers, which have a smaller effective field-of-view and require presentation of a target barcode to the reader in a very limited orientation to obtain a successful, decodable image, that is, an image of the target barcode that is decodable.

The camera systems of a multi-camera imaging reader may be positioned within the housing and with respect to the transparent windows such that when a target object is presented to the housing for reading the target barcode on the target object, the target object is imaged by the plurality of imaging camera systems, each camera providing a different image of the target object. U.S. patent application Ser. No. 11/862,568 filed Sep. 27, 2007 entitled ‘Multiple Camera Imaging Based Bar Code Reader’ is assigned to the assignee of the present invention and is incorporated herein by reference.

In the above conventional systems, a barcode can dwell within the FOV for a long time and data will only be transmitted once. If the barcode is moved out of the FOV of the scanner long enough for the timer to time-out, and then move back into the FOV, the barcode will be decoded and the sequence of events will repeat. If on the other hand, a new barcode (with different data encoded) passes into the FOV before the time-out has occurred, the new data will be transmitted immediately. This transmission is typically accepted because the new decoded data is different from the data stored from the previous barcode.

### SUMMARY

One example embodiment of the present disclosure includes a multi-camera imaging-based scanner for imaging multiple target objects at substantially the same time. The scanner comprises a housing supporting one or more transparent windows that defines an interior region. The housing constructed to accommodate imaging one or more products or packages presented to the scanner having a target object, the scanner imaging packages' or products' respective target object at substantially the same time The scanner further comprises an imaging system, including a plurality of cameras wherein each camera is positioned within the housing interior region, each camera having a field-of-view that is different than a field-of-view of each other camera of the plurality of cameras. The field-of-views of all the cameras define a scan field and each camera further comprising a sensor array. The scanner further comprises an image processing system having memory programmed to identify overlapping areas of the field-of-views of the cameras within the scan field, such that if a target object is imaged by more than one camera at substantially the same time in one of the over lapping areas between two or more cameras' field-of-views, the processing system defines that a single target object has been detected and the decoded information therefrom is processed only once. The scanner further programmed such that if multiple target objects are imaged by more than one camera at substantially the same time outside of any of the over lapping areas between two or more cameras' field-of-views, the processing system defines that multiple target objects have been detected and the decoded information for each target object is processed.

Another example embodiment of the present disclosure includes a method of operating a multi-camera imaging-based scanner for determining the number of target objects to be processed when the scanner is exposed one or more target objects. The method comprises the steps of providing an imaging-based scanner, including a housing supporting one or more transparent windows and defining an interior region of the scanner. The method further comprises the step of positioning multiple cameras having sensor arrays within the housing interior to define different a field-of-view for each of the plurality of cameras. The different field-of-views collectively forming a scan field such that one or more target objects cannot pass through the scan field without being imaged by at least one of the cameras. The method also comprises the steps of providing an image processing system in communication with the scanner having memory programmed to identify overlapping areas of the cameras' field-of-views within the scan field and processing only decoded information from a single target object if the single target object is imaged by more than one camera at substantially the same time in one of the over lapping areas between two or more cameras' field-of-views.

Yet another example embodiment of the present disclosure includes a multi-camera imaging-based scanner for imaging multiple identical target objects at substantially the same time. The imaging based scanner comprises a housing means supporting one or more transparent windows and defining an interior region, the housing means constructed to accommodate imaging one or more products or packages presented to the scanner having a target object, the scanner imaging packages' or products' respective target object at substantially the same time. The imaging based scanner further comprises an imaging means, including a plurality of camera wherein each camera is positioned within the housing means interior region. Each camera has a field-of-view that is different than a field-of-view of each other camera of the plurality of cameras. The field-of-views of all the cameras defining a scan field, each camera further comprises a sensor means. The imaging based scanner further comprises an image processing means having memory means programmed to identify overlapping areas of the field-of-views of the cameras within the scan field, such that if a target object is imaged by more than one camera at substantially the same time in one of the over lapping areas between two or more cameras' field-of-views. The processing means defines that a single target object has been detected and the decoded information therefrom is processed only once, if multiple identical target objects are imaged by more than one camera at substantially the same time outside of any of the over lapping areas between two or more cameras' field-of-views, the processing means defines that multiple target objects have been detected and the decoded information for each target object is processed.

While yet another example embodiment of the present disclosure comprises computer-readable media having computer-executable instructions for performing a method of operating an imaging-based scanner having multiple cameras for imaging multiple target objects at substantially the same time. The steps of the method comprise providing an imaging-based scanner, including a housing supporting one or more transparent windows and defining an interior region of the scanner. The steps further comprise positioning multiple cameras having sensor arrays within the housing interior to define different a field-of-view for each of the plurality of cameras. The different field-of-views collectively forming a scan field such that one or more target objects cannot passthrough the scan field without being imaged by at least one of the cameras. The method further comprises the step of providing an image processing system in communication with the scanner having memory programmed to identify overlapping areas of the cameras' field-of-views within the scan field and processing only decoded information from a single target object if the single target object is imaged by more than one camera at substantially the same time in one of the over lapping areas between two or more cameras' field-of-views.

### BRIEF DESCRIPTION OF THE DRAWINGS

The foregoing and other features and advantages of the present disclosure will become apparent to one skilled in the art to which the present disclosure relates upon consideration of the following description of the invention with reference to the accompanying drawings, wherein like reference numerals, unless otherwise described refer to like parts throughout the drawings and in which:

FIG 1. is a perspective view of a multi-imaging scanner constructed in accordance with one embodiment of the present disclosure for reading multiple images having a vertical and a horizontal window through which target objects are view by multiple cameras within the multi-imaging scanner that collectively form a scan field;

FIG. 2 is a top view of the scanner of FIG. 1 with a portion of the scanner housing removed to illustrate a field of view of a first imaging camera;

FIG. 3 is a front view of the scanner of FIG. 1 with a portion of the scanner housing removed to illustrate the field of view of the first imaging camera;

FIG. 4 is top view of the scanner of FIG. 1 with a portion of the scanner housing removed to illustrate a field of view of a second imaging camera;

FIG. 5 is a front view of the scanner of FIG. 1 with a portion of the scanner housing removed to illustrate the field of view of the second imaging camera;

FIG. 6 is a top view of the scanner of FIG. 1 with a portion of the scanner housing removed to illustrate the combined field of views of first and second imaging cameras of FIGS. 2-5;

FIG. 7 is a front view of the scanner of FIG. 1 with a portion of the scanner housing removed to illustrate the combined field of views of the first and second imaging cameras of FIGS. 2-5;

FIG. 8 is a top view of the scanner of FIG. 1 with a portion of the scanner housing removed to illustrate a third imaging camera;

FIG. 9 is a side view of the scanner of FIG. 1 with a portion of the scanner housing removed to illustrate the third imaging camera;

FIG. 10 is a top view of the scanner of FIG. 1 with a portion of the scanner housing removed to illustrate the combined field of views of first, second, and third imaging cameras of FIGS. 2-9;

FIG. 11 is a side view of the scanner of FIG. 1 with a portion of the scanner housing removed to illustrate the combined field of views first, second, and third imaging cameras of FIGS. 2-10;

FIG. 12 is a front view of the scanner of FIG. 1 with a portion of the scanner housing removed to illustrate the combined field of views first, second, and third imaging cameras;

FIG. 13 is a top view of the scanner of FIG. 1 with a portion of the scanner housing removed to illustrate a field of view of a fourth imaging camera;

FIG. 14 is a front view of the scanner of FIG. 1 with a portion of the scanner housing removed to illustrate the field of view of the fourth imaging camera;

FIG. 15 is a top view of the scanner of FIG. 1 with a portion of the scanner housing removed to illustrate a field of view of a fifth imaging camera;

FIG. 16 is a front view of the scanner of FIG. 1 with a portion of the scanner housing removed to illustrate the field of view of the fifth imaging camera;

FIG. 17 is a top view of the scanner of FIG. 1 with a portion of the scanner housing removed to illustrate the combined field of views fourth and fifth imaging cameras;

FIG. 18 is a front view of the scanner of FIG. 1 with a portion of the scanner housing removed to illustrate the combined field of views of fourth and fifth imaging cameras;

FIG. 19 is a top view of the scanner of FIG. 1 with a portion of the scanner housing removed to illustrate a field of view of a sixth imaging camera;

FIG. 20 is a side view of the scanner FIG. 1 with a portion of the scanner housing removed to illustrate the field of view of the sixth imaging camera;

FIG. 21 is a top view of the scanner of FIG. 1 with a portion of the scanner housing removed to illustrate the combined field of views of fourth, fifth, and sixth imaging cameras;

FIG. 22 is side view of the scanner of FIG. 1 with a portion of the scanner housing removed to illustrate the combined field of views of the fourth, fifth, and sixth imaging cameras;

FIG. 23 is a front view of the scanner of FIG. 1 with a portion of the scanner housing removed to illustrate the combined field of views of the fourth, fifth and sixth imaging cameras;

FIG. 24 is a top view of a multi-imaging scanner constructed in accordance with another embodiment of the present disclosure for reading multiple images having a vertical and a horizontal window through which target objects are viewed by multiple cameras within the multi-imaging scanner that collectively form a scan field, the multi-imaging scanner includes a single printed circuit board for housing the imaging cameras.

FIG. 25 is a side view of the scanner of FIG. 24 further illustrating a single printed circuit board for housing imaging cameras C1, C2, and C3;

FIG. 26 is a perspective view of the scanner of FIG. 24 further illustrating a single printed circuit board for housing imaging cameras C1, C2, and C3;

FIG. 27 is a perspective view of the scanner of FIG. 24 further illustrating a single printed circuit board for housing imaging cameras C1-C6;

FIG. 28 is a schematic block diagram of selected systems and electrical circuitry of the scanner of FIGS. 1 and 24;

FIG. 29 is a perspective view of the scanner of FIGS. 1 and 24 in operation imaging a single target object in a scan field;

FIG. 30 is a perspective view of the scanner of FIGS. 1 and 24 in operation imaging multiple target objects in a scan field; and

FIG. 31 is flowchart of an exemplary embodiment of the disclosure.

### DETAILED DESCRIPTION

The present disclosure relates to a multi-imager scanner for reading multiple images. In particular, the present disclosure teaches a system, apparatus, and method for maximizing scanning productivity by enabling the imaging of multiple identical indicia on target packages at the same time or in very close time succession.

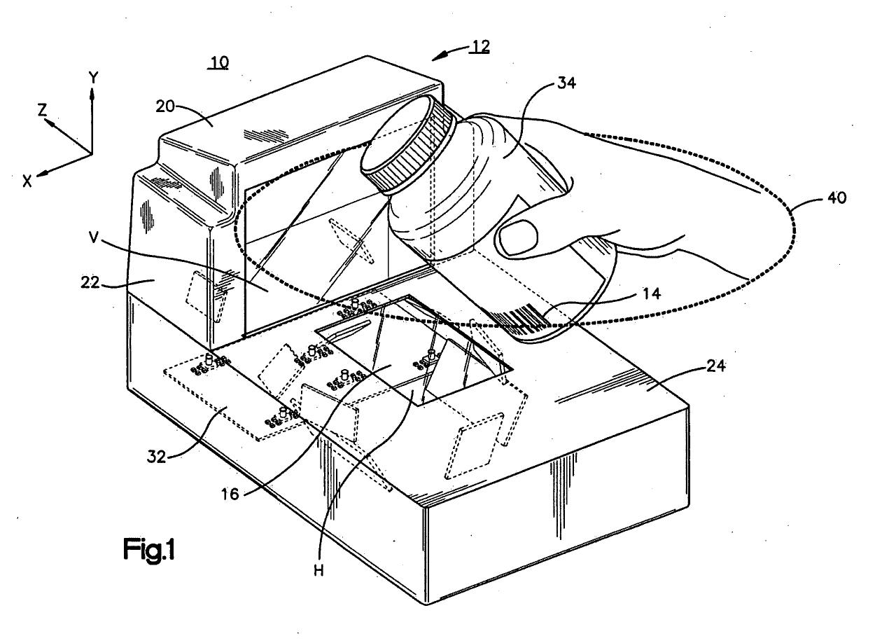

With reference now to the figures, and in particular with reference to FIG. 1, there is depicted an exemplary embodiment of an imaging system 10, comprising a multi-imager scanner 12 for reading multiple images. The imaging system 10 is capable of reading, that is, imaging and decoding target objects 14 comprising both 1D and 2D bar codes, postal codes, hard and soft images, signatures and the like.

In the illustrated embodiment of FIG. 1, the mufti-imaging scanner 12 is a presentation scanner or bi-optic scanner that is integrated into a sales counter that of a point-of-sales system that includes, for example, a cash register, a touch screen visual display or other type user interface and a printer for generating sales receipts. The multi-imaging scanner 12 includes a housing 20 depicted in FIG. 1 that includes two transparent windows, a horizontal window (“H”) and vertical window (“V”). In an alternative embodiment (not shown), the multi-imaging scanner is a hand-held imager capable of remotely scanning target objects by a user during operation.

In the illustrated exemplary embodiment, the multi-imaging scanner 12 is stationary and image arid decoder systems are supported within an interior region 16 of the housing 20. The housing 20 further comprises an upper portion 22 for supporting the vertical window V and a base portion 24, supporting the horizontal window H.

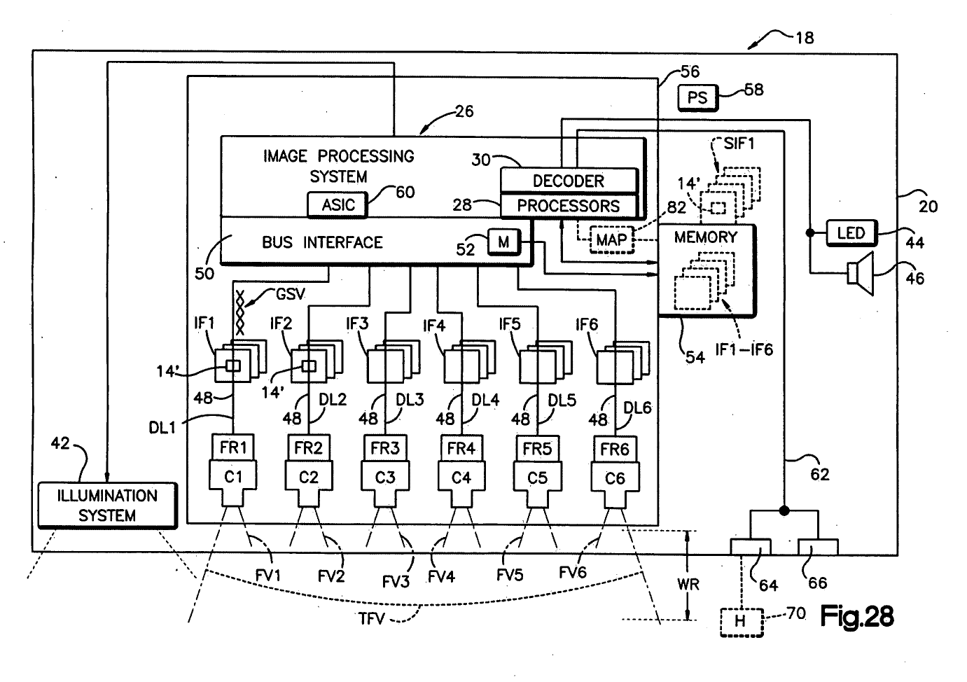

FIG. 28 is a schematic block diagram of selected systems and electrical circuitry 18 of the multi-imaging scanner 12 that includes a plurality of imaging cameras C1, C2, C3, C4, C5, C6, which produce raw gray scale images, and an image processing system 26, which includes one or more processors 28 and a decoder 30 that analyzes the gray scale images from the cameras and decodes imaged target objects 14, if present. The above processors 28 and decoder 30 may be integrated into the multi-imaging scanner 12 or may be a separate system, as would be understood by one of skill in the art.

In the exemplary embodiment, the cameras C1-C6 are mounted to a printed circuit board 32 (see FIG. 1) inside the housing 20 and each camera C defines a two dimensional field-of-view FV1, FV2, FV3, FV4, FV5, FV6. Positioned behind and adjacent to the windows H, V are reflective mirrors (“M”) that help define a given camera field-of-view such that the respective fields-of-view FV1-FV6 pass from the housing 20 through the windows creating an effective total field-of-view (“TFV”) forming a scan field 40 for the multi-imaging scanner 12 in a region of the windows H, V, outside the housing 20. Because each camera C1-C6 has an effective working range WR (shown schematically in FIG. 28) over which a target object 14 may be successfully imaged and decoded, there is an effective target area (the scan field 40) in front of the windows H,V within which a target object 14 presented for reading may be successfully imaged and decoded.

The imaging cameras C1-C6 are arranged such that their field-of-views FV1-FV6 make it impossible for a target object 14 to move through the scan field 40 without being seen by at least one imaging camera. In the exemplary multi-imaging scanner 12, three of the cameras C4-C6, look out of a vertical window V with the help of reflecting mirrors (“M”) and three cameras C1-C3 look out of a horizontal window H and their field-of-views collectively form the scan field 40. In use, a user slides a package or container 34 having a target object 14 such as a barcode through the scan field 40 in front of the windows. The target object 14 may be visible to cameras behind the vertical window, or to cameras behind the horizontal window, or both. The target object 14 may move through the center of the scan field 40 of the cameras, or through one end or the other of the scan field.

Each camera assembly C1-C6 of the imaging system 10 captures a series of image frames of its respective field of view FV1-FV6. The series of image frames for each camera assembly C1-C6 is shown schematically as IF1, IF2, IF3, IF4, IF5, IF6 in FIG. 28. Each series of image frames IF1-IF6 comprises a sequence of individual image frames generated by the respective cameras C1-C6. As seen in the drawings, the designation IF1, for example, represents multiple successive images obtained from the camera C1. As is conventional with imaging cameras, the image frames IF1-1F6 are in the form of respective digital signals representative of raw gray scale values generated by each of the camera assembly C1-C6.

An exemplary illumination system 42 has one or more high energy light emitting diodes L1-L6 associated with each of the cameras C1-C6. In an alternative embodiment (not shown), the illumination system 42 is made up of cold cathode fluorescent lamps (CCFLs) or a combination of LEDs and CCFLs.

In the exemplary embodiment, the multi-imaging scanner 12 reads target objects 14 such as barcodes moving through the scan field 40 with a speed of approximately 100 inches per second, and images the target object regardless of its orientation with respect to the windows V, H. In accordance with one use, either a sales person or a customer will present a product or container 34 selected for purchase to the housing 20. More particularly, a target object 14 imprinted or affixed to the product or product's container 34 will be presented in a region near the windows H, V into the scan field 40 for reading, that is, imaging and decoding of the coded indicia of the target object. Upon a successful reading of the target object 14, a visual and/or audible signal will be generated by the multi-imaging scanner 12 to indicate to the user that the target object 14 has been successfully imaged and decoded. The successful read indication may be in the form of illumination of a light emitting diode (LED) 44 (FIG. 28) and/or generation of an audible sound by a speaker 46 upon generation of an appropriate signal from the decoder 30.

The image processor or processors 28 controls operation of the cameras C1-C6. The cameras C1-C6, when operated during an imaging system, generate digital signals 48. The signals 48 are raw, digitized gray scale values which correspond to a series of generated image frames for each camera. For example, for the camera C1, the signal 48 corresponds to digitized gray scale values corresponding to a series of image frames IF1. For the camera C2, the signal 48 corresponds to digitized gray scale values corresponding to a series of image frame IF2, and so on. The digital signals 48 are coupled to a bus interface 50, where the signals are multiplexed by a multiplexer 52 and then communicated to a memory 54 in an organized fashion so that the processor knows which image representation belong to a given camera.

The image processors 15 access the image frames IF1-IF6 from memory 44 and search for image frames that include an imaged target object 14′. If the imaged target object 14′ is present and decodable in one or more image frames, the decoder 30 attempts to decode the imaged target object 14′ using one or more of the image frames having the imaged target 14′ or a portion thereof.

Each camera includes a charged coupled device (“CCD”), a complementary metal oxide semiconductor (“CMOS”), or other imaging pixel array, operating under the control of the imaging processing system 26. In one exemplary embodiment, the sensor array comprises a two dimensional (“2D”) CMOS array with a typical size of the pixel array being on the order of 752×480 pixels. The illumination-receiving pixels of the sensor array define a sensor array surface secured to a printed circuit board 32 for stability. The sensor array surface is substantially perpendicular to an optical axis of the imaging lens assembly, that is, a z axis that is perpendicular to the sensor array surface would be substantially parallel to the optical axis of the focusing lens. The pixels of the sensor array surface are disposed in an orthogonal arrangement of rows and columns of pixels.

The multi-imaging scanner 12 circuitry 18 includes imaging system 56, the memory 54 and a power supply 58. The power supply 58 is electrically coupled to and provides power to the circuitry 18 of the multi-imaging scanner 12. Optionally, the multi-imaging scanner 12 may include an illumination system 42 (shown schematically in FIG. 28) which provides illumination, to illuminate the effective total field-of-view and scan field 40 to facilitate obtaining an image 14′ of a target object 14 that has sufficient resolution and clarity for decoding.

For each camera assembly C1-C6, electrical signals are generated by reading out of some or all of the pixels of the pixel array after an exposure period generating the gray scale value digital signal 48. This occurs as follows: within each camera, the light receiving photosensor/pixels of the sensor array are charged during an exposure period. Upon reading out of the pixels of the sensor array, an analog voltage signal is generated whose magnitude corresponds to the charge of each pixel read out. The image signals 48 of each camera assembly C1-C6 represents a sequence of photosensor voltage values, the magnitude of each value representing an intensity of the reflected light received by a photosensor/pixel during an exposure period.

Processing circuitry of the camera assembly, including gain and digitizing circuitry, then digitizes and coverts the analog signal into a digital signal whose magnitude corresponds to raw gray scale values of the pixels. The series of gray scale values GSV represent successive image frames generated by the camera assembly. The digitized signal 48 comprises a sequence of digital gray scale values typically ranging from 0-255 (for an eight bit A/D converter, i.e., 2⁸⁼²⁵⁶), where a 0 gray scale value would represent an absence of any reflected light received by a pixel during an exposure or integration period (characterized as low pixel brightness) and a 255 gray scale value would represent a very intense level of reflected light received by a pixel during an exposure period (characterized as high pixel brightness). In some sensors, particularly CMOS sensors, all pixels of the pixel array are not exposed at the same time, thus, reading out of some pixels may coincide in time with an exposure period for some other pixels.

As is best seen in FIG. 28, the digital signals 48 are received by the bus interface 50 of the image processing system 56, which may include, the multiplexer 52, operating under the control of an ASIC 60, to serialize the image data contained in the digital signals 48, The digitized gray scale values of the digitized signal 48 are stored in the memory 54. The digital values GSV constitute a digitized gray scale version of the series of image frames IF1-IF6, which for each camera assembly C1-C6 and for each image frame is representative of the image projected by the imaging lens assembly onto the pixel array during an exposure period. If the field-of-view of the imaging lens assembly includes the target object 14, then a digital gray scale value image 14′ of the target object 14 would be present in the digitized image frame.

The decoding circuitry 26 then operates on selected image frames and attempts to decode any decodable image within the image frames, e.g., the imaged target object 14′. If the decoding is successful, decoded data 62, representative of the data/information coded in the target object 14 may then be processed or output via a data port 64 to an external computer which also may communicate data to the reader used in reprogramming the camera used to detect objects. A successful decode can also be displayed to a user of the multi-imaging scanner 12 via a display output 66. Upon achieving a good read of the target object 14, such as a target barcode or signature was successfully imaged and decoded, the speaker 46 and/or an indicator LED 44 may then be activated by the multi-imaging scanner circuitry 18 to indicate to the user that the target object 14 has successfully read.

### Scanning Multiple Images

In conventional imaging systems if two items have different target barcodes, existing scanners can read them both and transmit data from both of them. If, on the other hand, two identical items are being scanned simultaneously, they will both have the same data encoded into their barcodes, and the scanner will not allow one of them to decode, since it will not be able to distinguish between two items with the same barcode. Alternatively, one item can remain in the field-of-view long enough to decode two times, which disadvantageous is an unknown time period for the user, especially in a self-checkout line. Sometimes, operators are in such a hurry that will grab a barcoded package with each hand and attempt to scan them at the same time, only to be burdened with the inability to scan both objects simultaneously with the conventional scanner. This inability of a conventional scanner to process two items with identical barcodes rapidly limits the ultimate throughput of the scanner.

In the exemplary embodiment, the multi-imaging scanner 12 is capable of imaging of multiple identical indicia (target objects 14) oh target packages 34 at the same time or in very close time succession. The six imaging cameras C1-C6 are positioned to enable the scanning of all sides of a package or product, in the illustrated embodiment an entire cylindrical surface or in a box (not shown) six sides can be imaged as it passes through the scan field 40. The construction of the imaging cameras C1-C6 in combination with the programming of the imaging processing system 26 or a remote programmable processor (not shown) further discussed below enables the multi-imaging scanner 12 to distinguish between two identical packages being passed through the scan field 40 simultaneously or in very close succession. The imaging system 10 further assures that there are in fact, two or more target objects 14 on separate packages 34 to be scanned opposed to a single target object being scanned multiple times.

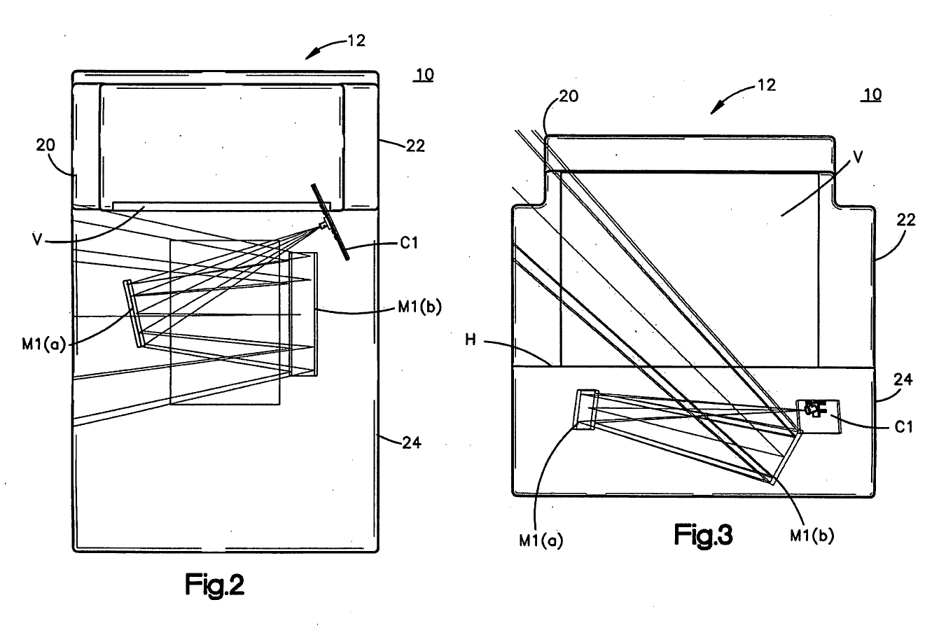

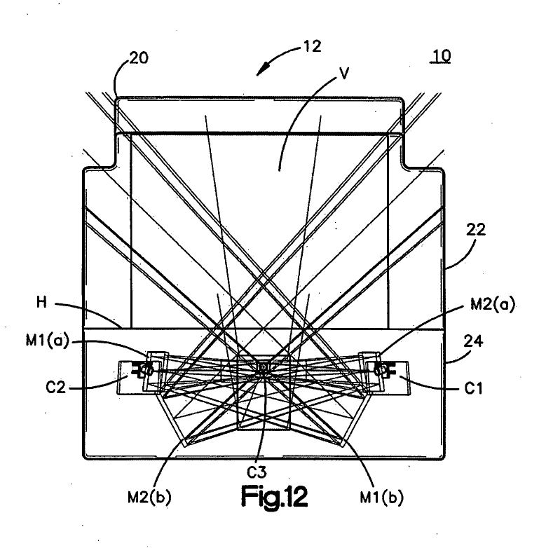

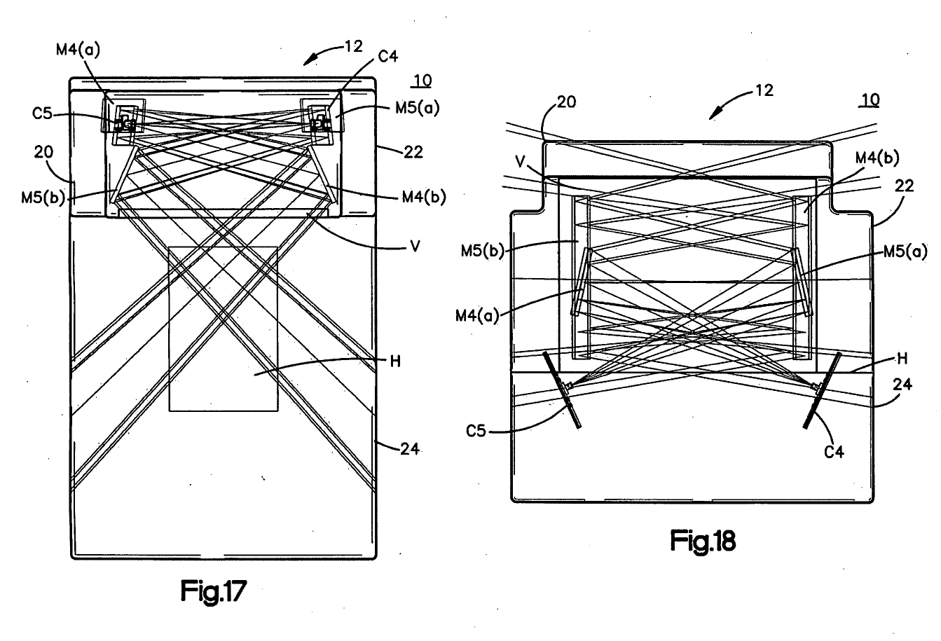

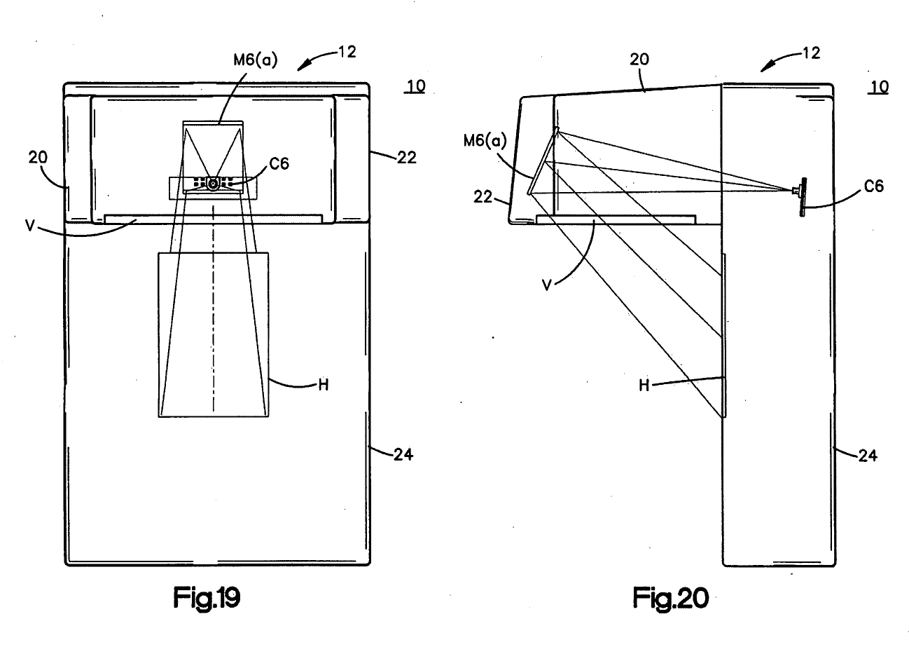

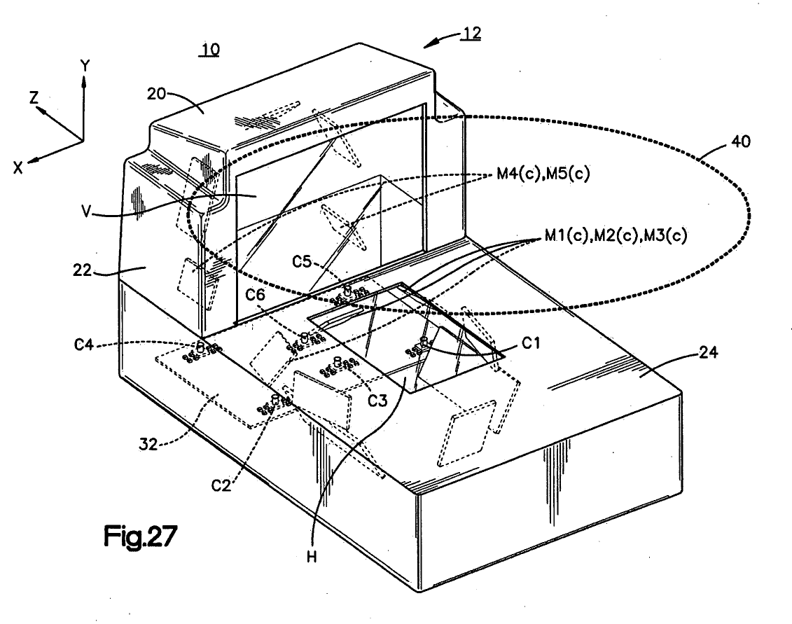

As best seen in the figures, specifically FIGS. 2-25, respective imaging cameras C1-C6 are positioned for seeing all sides or surfaces packages or products 34 entering the scan field 40 and some pairs of imaging cameras (e.g., C1 and C2 as illustrated in FIG. 12, C4 and C5 as illustrated in FIG. 17, and C3 and C6 as illustrated in FIG. 27) are positioned to see opposite sides or surfaces of the packages or products. Since there is only a single target object 14 on each package 34 entering the scan field 40, if these opposing cameras (e.g., C1-C2, C4-C5, and C3-C6) see target objects 14 with the same encoded data at substantially the same time, the processing system 26 or remote processor (not shown) coupled to the scanner 12 is program to assume that the target objects 14 are affixed on different products or packages 34 and the images are properly decoded by the imaging processing system 26 and processed or transferred to a host 70, display output 66, and/or the like. Under such condition that the opposing cameras image identical target objects 14 in different fields-of-view at substantially the same time the image processing system 26 recognizes that there are multiple identical target objects 14 associated with multiple packages 34 in the scan field 40, in contrast to a single package decoded multiple times. Stated another way, if images of two identical target objects 14 such as barcodes are captured in a single image frame IF1, IF2, IF3, EF4, IF5, IF6 of any of the multiple imaging cameras C1-C6, the imaging processing system 26 (or remote processor coupled to the scanner 12) is programmed to distinguish that target barcodes are not from a single or the same barcode and the data from each target object 14 can be safely transmitted or decoded.

Referring again to the figures and in particular FIGS. 2 and 3, an exemplary embodiment of the multi-imaging scanner 12 is shown having imaging camera C1 and its orientation from a top view (FIG. 2) and front view (FIG. 3). The FOV of C1 is further illustrated in both FIGS. 2 and 3, which is projected from the horizontal window H, facilitated by the positioning of reflective mirrors M1(a) and M1(b).

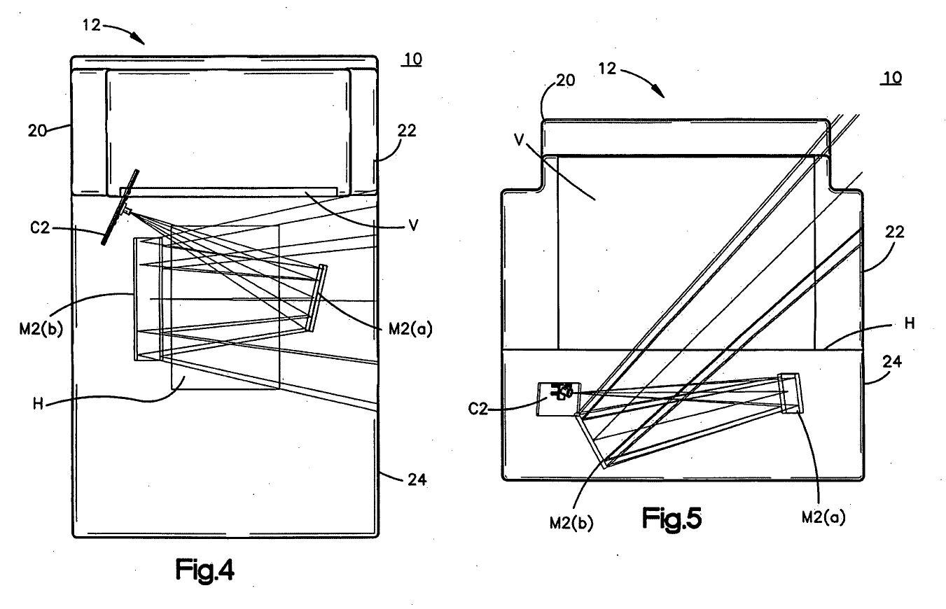

Illustrated in FIGS. 4 and 5 is an exemplary embodiment of the multi-imaging scanner 12, comprising imaging camera C2 and its orientation from a top view (FIG. 4) and front view (FIG. 5). The FOV of C2 is further illustrated in both FIGS. 4 and 5, which is projected from the horizontal window H at a direction opposite that of C1, which is facilitated by the positioning of reflective mirrors M2(a) and M2(b).

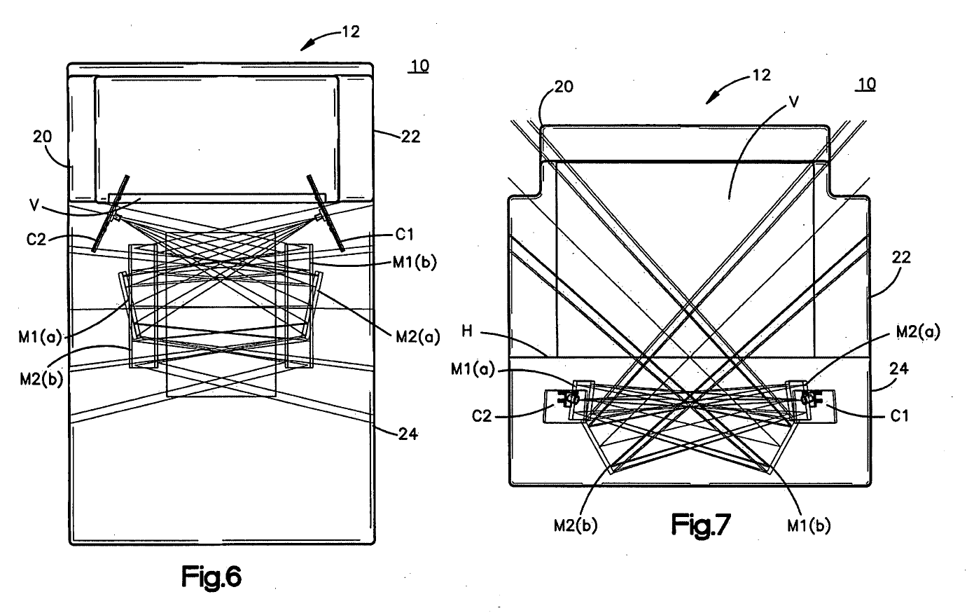

Illustrated in FIGS. 6 and 7 is an exemplary embodiment of the multi-imaging scanner 12, combining the imaging cameras C1 and C2 and their orientations from a top view (FIG. 6) and front view (FIG. 7). The FOVs of C1 and C2 are further illustrated in both FIGS. 6 and 7, which are projected from the horizontal window H at directions opposite each other.

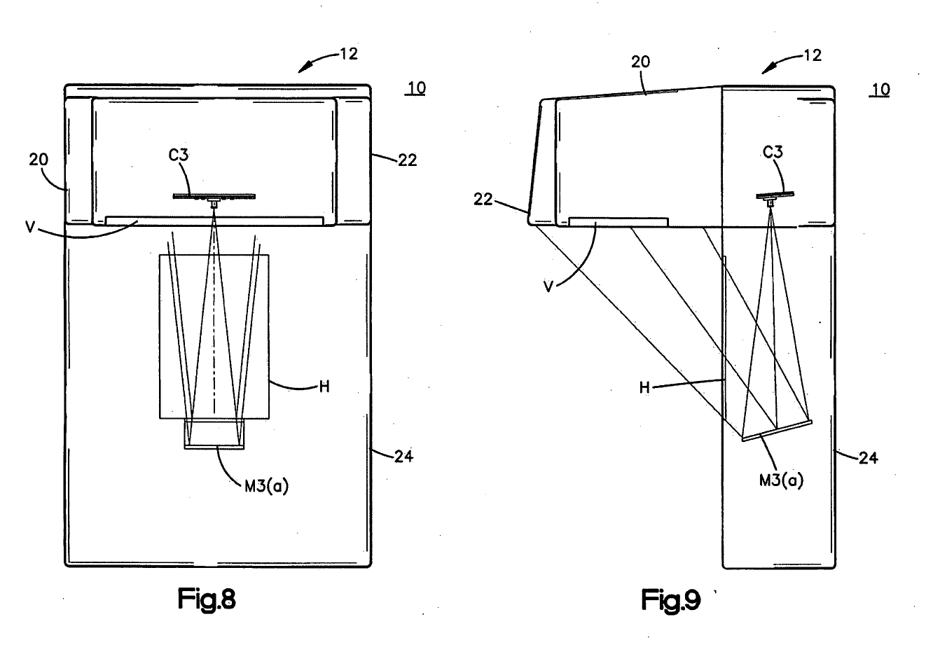

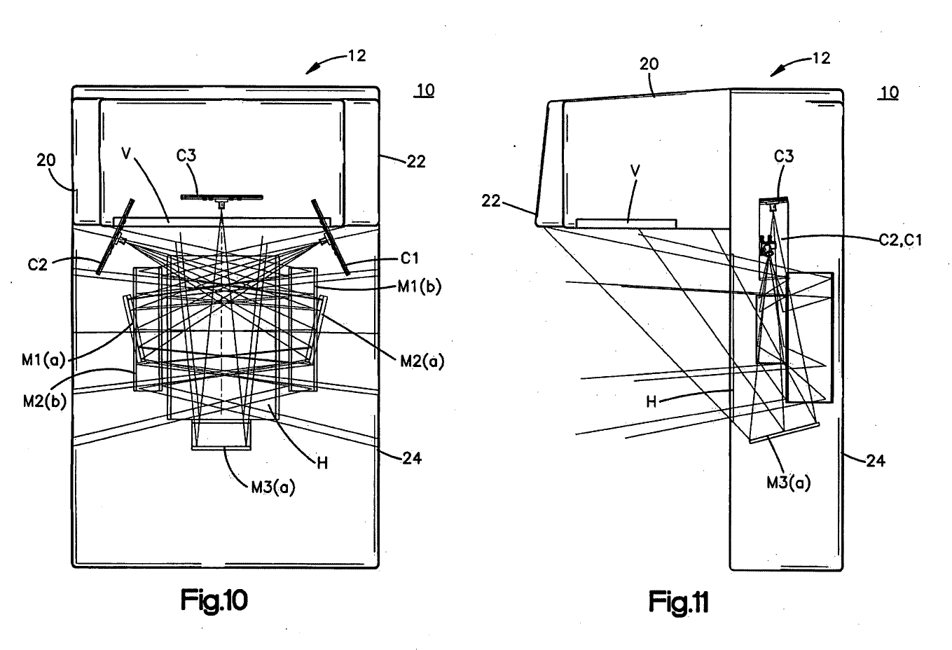

Referring now to FIGS. 8 and 9 is an exemplary embodiment of the multi-imaging scanner 12, comprising imaging camera C3 and its orientation from a top view (FIG. 8) and side view (FIG. 9). The FOV of C3 is further illustrated in both FIGS. 8 and 9, which is projected from the horizontal window H facilitated by the positioning of reflective mirror M3(a). Illustrated in FIGS. 10, 11, and 12 is an exemplary embodiment of the multi-imaging scanner 12, combining the imaging cameras C1, C2, and C3 and their orientations from a top view (FIG. 10), side view (FIG. 11), and front view (FIG. 12). The FOVs of C1, C2, and C3 are further illustrated in FIGS. 10-12, which are projected from the horizontal window H.

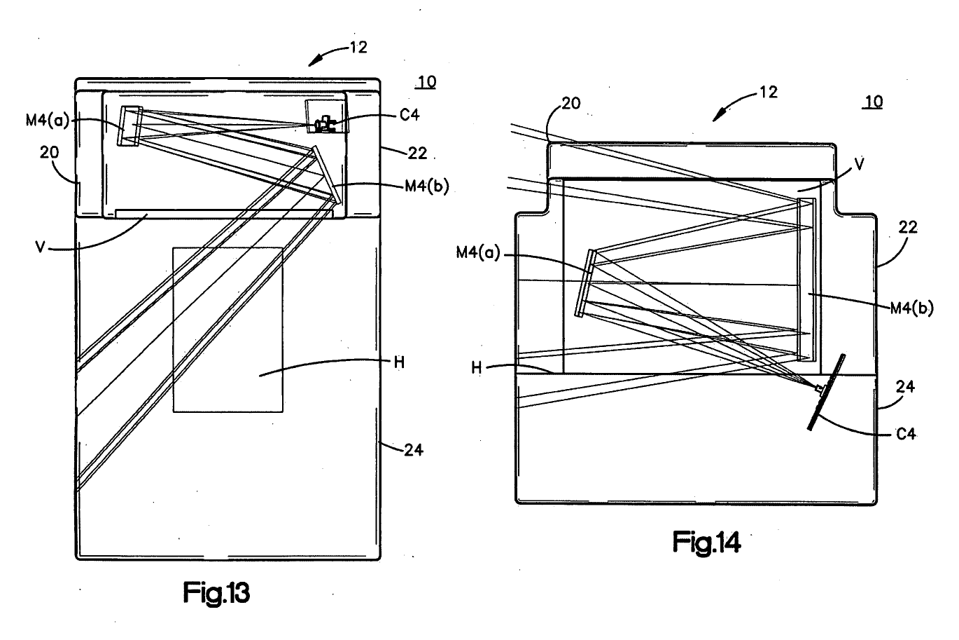

Illustrated in FIGS. 13 and 14 is an exemplary embodiment of the multi-imaging scanner 12, comprising imaging camera C4 and its orientation from a top view (FIG. 13) and front view (FIG. 14). The FOV of C4 is further illustrated in both FIGS. 13 and 14, which is projected from the vertical window V, which is facilitated by the positioning of reflective mirrors M4(a) and M4(b).

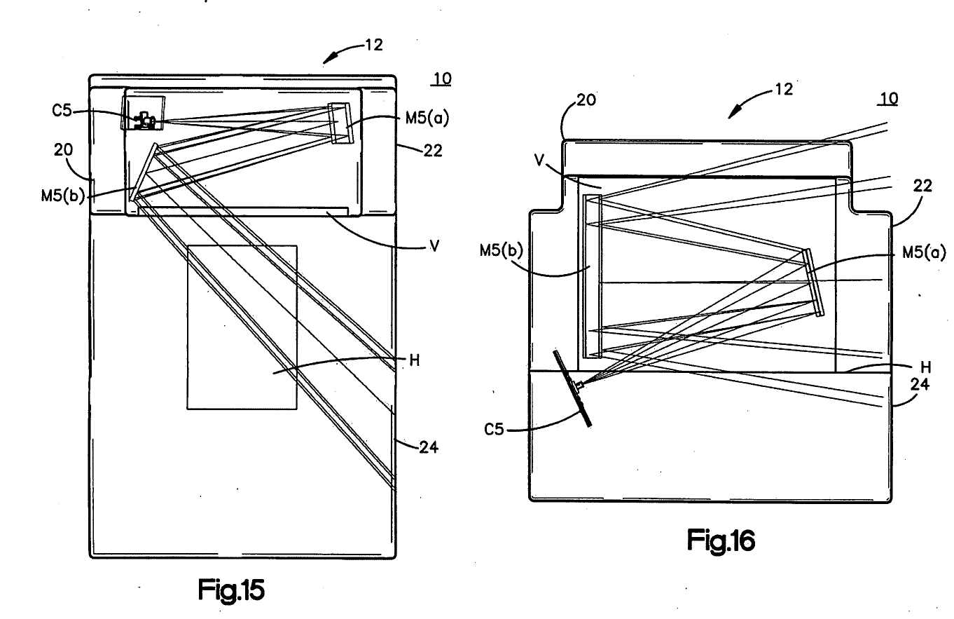

Referring now to FIGS. 15 and 16 is an exemplary embodiment of the multi-imaging scanner 12, comprising imaging camera C5 and its orientation from a top view (FIG. 15) and front view (FIG. 16). The FOV of C5 is further illustrated in both FIGS. 15 and 16, which is projected from the vertical window V, which is facilitated by the positioning of reflective mirrors M5(a) and M5(b). Illustrated in FIGS. 17 and 18 is an exemplary embodiment of the multi-imaging scanner 12, combining the imaging cameras C4 and C5 and their orientations from a top view (FIG. 17) and front view (FIG. 18). The FOVs of C4 and C5 are further illustrated in both FIGS. 17 and 18, which are projected from the vertical window V at directions opposite each other.

Illustrated in FIGS. 19 and 20 is an exemplary embodiment of the multi-imaging scanner 12, comprising imaging camera C6 and its orientation from a top view (FIG. 19) and side view (FIG. 20). The FOV of C6 is further illustrated in both FIGS. 19 and 20, which is projected from the vertical window V facilitated by the positioning of reflective mirror M6(a).

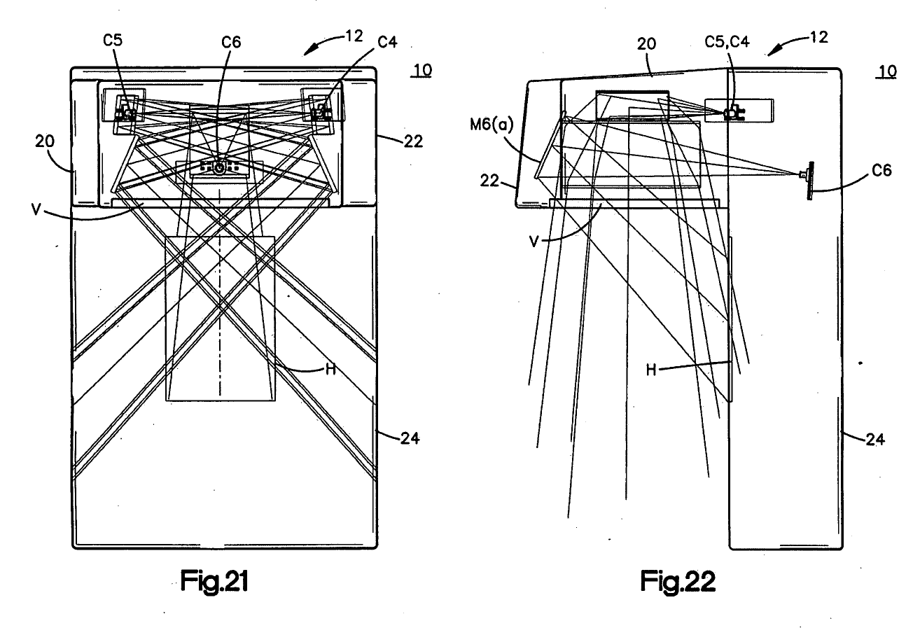

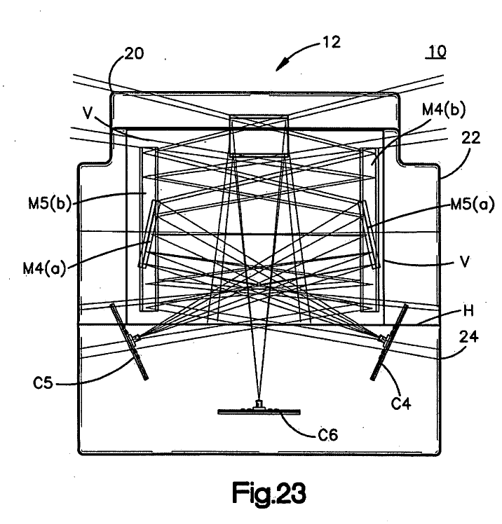

Referring now to FIGS. 21, 22, and 23 is an exemplary embodiment of the multi-imaging scanner 12, combining the imaging cameras C4, C5, and C6 and their orientations from a top view (FIG. 21), side view (FIG. 22), and front view (FIG. 23). The FOVs of C4, C5, and C6 are further illustrated in FIGS. 21-23, which are projected from the vertical window V.

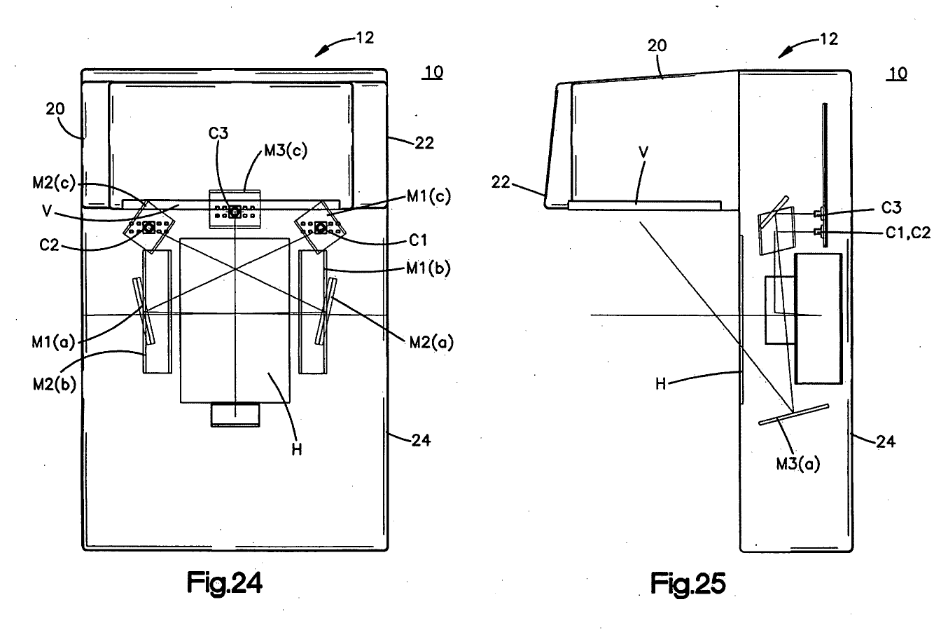

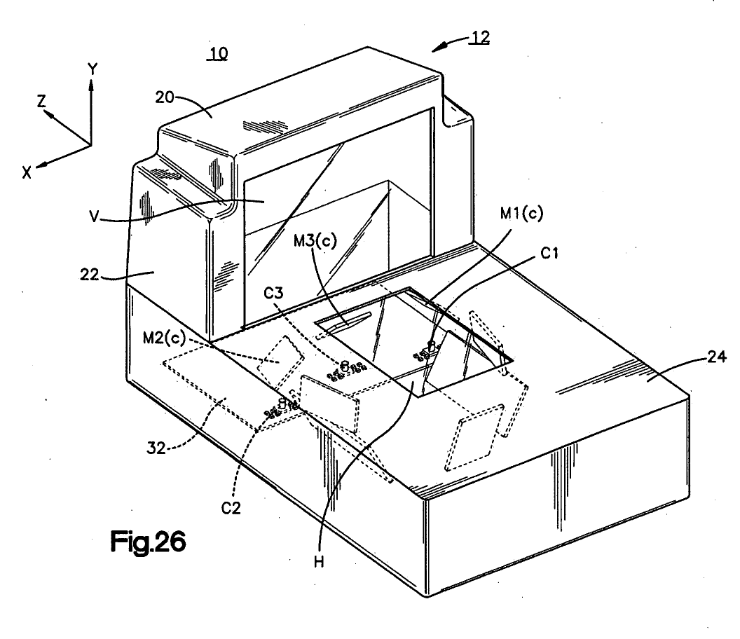

Illustrated in FIGS. 24-27 is yet another exemplary embodiment in which fold-mirrors M1(c), M2(c), and M3(c) are used to replace the locations of the imaging cameras C1-C3 such that cameras C1-C3 are now oriented in a horizontal position such that all three cameras can be placed on a single printed circuit board 32. The fold mirrors M1(c)-M3(c) also advantageously allow the multi-imaging scanner 12 to be a more compact in design.

The exemplary embodiment of FIG. 27 of the multi-imaging scanner 12 illustrates the combining the imaging cameras C1-C6 and their orientations from a perspective view. The imaging cameras C1-C6 and their respective reflective mirrors M are oriented such that all imaging cameras C1-C6 are positioned on a single printed circuit board 32. The FOVs of C3 and C6 are further illustrated in FIG. 27, which are projected from the horizontal H and vertical V windows, respectively at directions opposite each other.

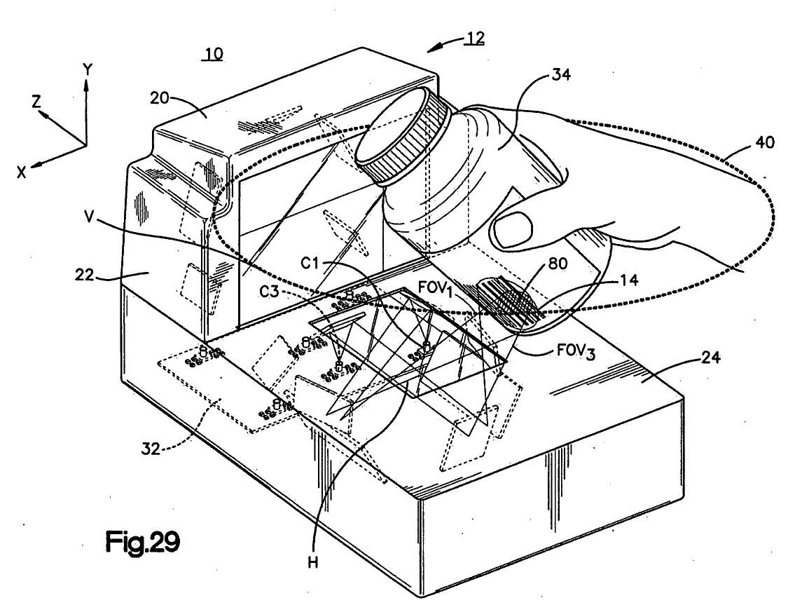

The imaging camera C1-C6 through their respective reflective mirrors M are oriented (as illustrated in FIGS. 1-27) such that their respective FOVs have multiple, respective overlapping areas 80 (see FIG. 29), making it impossible for a target object 14 on a product or package 34 pass through the scan field 40 without being seen and imaged by at least one imaging camera C1-C6. When a target object 14 passes through an area of overlap 80 as illustrated by example of the FOVs from imaging cameras C1 and C3 in FIG. 29, both imaging camera capture the same target object at substantially the same time. As a result of the target object being read by at least two FOVs of separate imaging cameras in an overlapping area 80, the imaging system 10 is programmed to recognize under such condition that this is a single target object 14 and as a result, the imaged data is processed or transmitted only one time.

The areas of overlap 80 are mapped 82, that is programmed into the image processing system 26, a remote processor coupled to the imaging scanner (not shown), or the memory 54 such that it can be determined if a single target object 14 is being imaged by more than one imaging camera C1-C6 at substantially the same time in an overlapping area. As such, it can be determined whether multiple or a single product 34 is entering the scan field 40 for imaging under all conditions. As long as the map 82 indicates that identical target objects 14 in the scan field 40 are in non-overlapping areas, the image processing system 26 determines that there are multiple target objects 14 and as a result, multiple products 34 and their respective target objects 14 are to be imaged, decoded and the resulting data for each target object is process, transferred, or both. Alternatively, the image processing system 26 is programmed or mapped 82 such that if a target object 14 is in the overlapping area 80, then only one product 34 and its respective target object 14 is to be imaged, decoded and the resulting data therefrom is transferred, processed, or both.

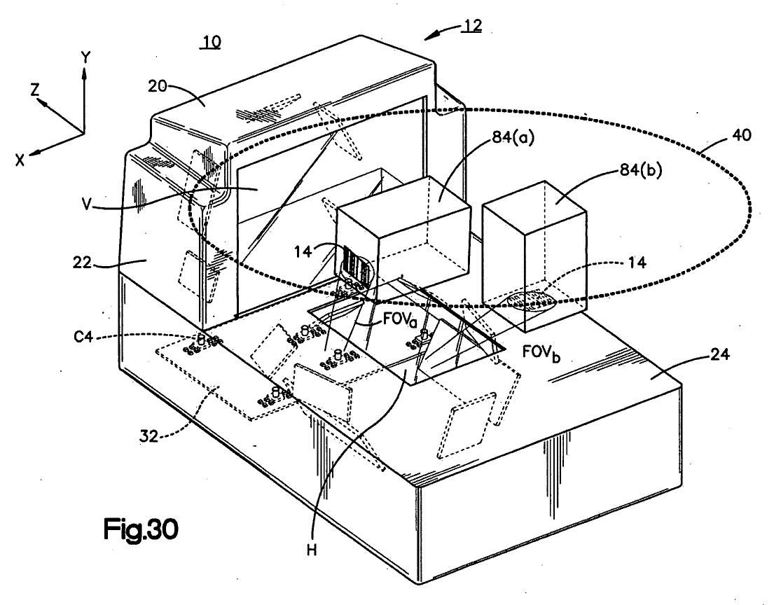

FIG. 30 illustrates the condition in which multiple packages 84(a) and 84(b) enter the scan field 40 and identical target objects 14 are seen by different imaging cameras at substantially the same time outside of overlapping areas 80. Accordingly, the imaging processing system 26 recognizes that multiple products 84(a) and 84(b) are present and their respective target objects 14 are to be imaged, decoded, and the resulting data transferred, processed, or both.

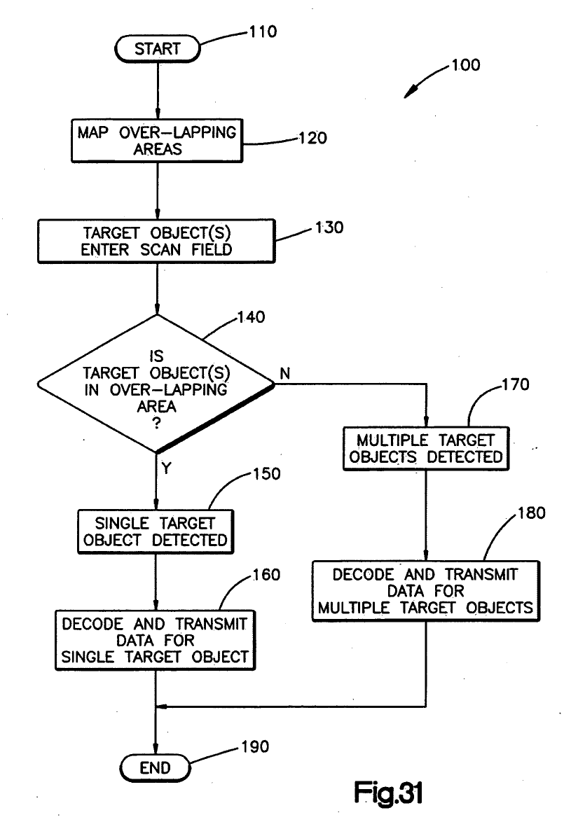

The multi-imaging capability of the exemplary multi-imaging scanner is explained in relation to the flowchart of FIG. 31. The scanning process is initiated at 110. The image processing system 26, memory 54, or a remote processor coupled to the scanner 12 is programmed or mapped to identify and recognize over lapping areas in the FOVs of imaging cameras C1-C6 at 120. Product(s) or package(s) having identical target object(s) 14 enter the scan field 40 at 120. The processor, processors or memory determines whether target object(s) 14 is captured in the over lapping areas 80 at 130. If the determination at 130 is affirmative, a single target object is detected at 150. The target object 14 is then decoded and data therefrom transferred to an output device, such as an LED 44, speaker 46, data port 64 to a host 70, display output 66, to a remote computer, or any combination thereof at 150.

If the determination at 140 is negative, multiple target objects 14 have been detected in the scan field 40 at 170. The target objects 14 are then decoded and data therefrom transferred to an output device, such as an LED 44, speaker 46, data port 64 to a host 70, display output 66, to a remote computer, or any combination thereof at 180. The process steps at 160 and 180 are terminated at 190.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A multi-camera imaging-based scanner for imaging multiple target objects at substantially the same time, the imaging based scanner comprising:
a housing supporting one or more transparent windows and defining an interior region, the housing constructed to accommodate imaging one or more products or packages presented to the scanner having a target object, the scanner imaging packages' or products' respective target object at substantially the same time;
an imaging system including a plurality of cameras wherein each camera is positioned within the housing interior region, each camera having a field-of-view that is different than a field-of-view of each other camera of the plurality of cameras, the field-of-views of all the cameras defining a scan field, each camera further comprising a sensor array; and
an image processing system having memory programmed to identify overlapping areas of said field-of-views of said cameras within said scan field, such that if a target object is imaged by more than one camera at substantially the same time in one of said over lapping areas between two or more cameras' field-of-views, the processing system defines that a single target object has been detected and the decoded information therefrom is processed only once, if multiple target objects are imaged by more than one camera at substantially the same time outside of any of said over lapping areas between two or more cameras' field-of-views, said processing system defines that multiple target objects have been detected and the decoded information for each target object is processed.

2. The multi-camera imaging-based scanner of claim 1 wherein said processing said decoded information comprises transferring the decoded information to an output of said scanner.

3. The multi-camera imaging-based scanner of claim 2 wherein said output of said scanner is in communication with at least any one of an LED, a speaker, a data port to a host, a display output, and a remote computer.

4. The multi-camera imaging-based scanner of claim 1 wherein said multiple target objects include at least two identical target objects.

5. The multi-camera imaging-based scanner of claim 1 wherein said target object is an image signature or a barcode.

6. The multi-camera imaging-based scanner of claim 1 wherein at least two cameras comprise opposing fields-of-view.

7. The multi-camera imaging-based scanner of claim 1 wherein said plurality of cameras comprise six cameras such that three pairs of said six cameras have opposing field-of-view with respect to each camera in said pair of the three pairs.

8. The multi-camera imaging-based scanner of claim 1 wherein said plurality of cameras are coupled to a single printed circuit board located within said interior of said housing.

9. A method of operating a multi-camera imaging-based scanner for determining the number of target objects to be processed when the scanner is exposed one or more target objects, the method comprising the steps of;
providing an imaging-based scanner, including a housing supporting one or more transparent windows and defining an interior region of said scanner;
positioning multiple cameras having sensor arrays within the housing interior to define different a field-of-view for each of said plurality of cameras, the different field-of-views collectively forming a scan field such that one or more target objects cannot pass through said scan field without being imaged by at least one of said cameras;
providing an image processing system in communication with said scanner having memory programmed to identify overlapping areas of said cameras' field-of-views within said scan field;
processing only decoded information from a single target object if the single target object is imaged by more than one camera at substantially the same time in one of said over lapping areas between two or more cameras' field-of-views.

10. The method of claim 9 further comprising the step of processing decoded information for each target object imaged within said scan field at substantially the same time where said target objects are outside of said over lapping areas.

11. The method of claim 9 wherein said step of processing decoded information comprises communicating the data to an output coupled at least any one of an LED, a speaker, a data port to a host, a display output, and a remote computer.

12. The method of claim 10 wherein at least two of said target objects imaged within said scan field at substantially the same time have identical indicium and data content.

13. A multi-camera imaging-based scanner for imaging multiple identical target objects at substantially the same time, the imaging based scanner comprising:
a housing means supporting one or more transparent windows and defining an interior region, the housing means constructed to accommodate imaging one or more products or packages presented to the scanner having a target object, the scanner imaging packages' or products' respective target object at substantially the same time;
an imaging means including a plurality of camera wherein each camera is positioned within the housing means interior region, each camera having a field-of-view that is different than a field-of-view of each other camera of the plurality of cameras, said field-of-views of all the cameras defining a scan field, each camera further comprising a sensor means; and
an image processing means having memory means programmed to identify overlapping areas of said field-of-views of said cameras within said scan field, such that if a target object is imaged by more than one camera at substantially the same time in one of said over lapping areas between two or more cameras' field-of-views, the processing means defines that a single target object has been detected and the decoded information therefrom is processed only once, if multiple identical target objects are imaged by more than one camera at substantially the same time outside of any of said over lapping areas between two or more cameras' field-of-views, said processing means defines that multiple target objects have been detected and the decoded information for each target object is processed.

14. The multi-camera imaging-based scanner of claim 13 wherein said processing said decoded information comprises transferring the decoded information to an output of said scanner.

15. The multi-camera imaging-based scanner of claim 14 wherein said output of said scanner is in communication with at least any one of an LED, a speaker, a data port to a host, a display output, and a remote computer.

16. The multi-camera imaging-based scanner of claim 14 wherein at least two cameras comprise opposing fields-of-view.

17. The multi-camera imaging-based scanner of claim 14 wherein said plurality of cameras comprise six cameras such that three pairs of said six cameras have opposing field-of-view with respect to each camera in said pair of the three pairs.

18. The multi-camera imaging-based scanner of claim 14 wherein said plurality of cameras are coupled to a single printed circuit board located within said interior of said housing.

19. Computer-readable media having computer-executable instructions for performing a method of operating an imaging-based scanner having multiple cameras for imaging multiple target objects at substantially the same time, the steps of the method comprising: providing an imaging-based scanner, including a housing supporting one or more transparent windows and defining an interior region of said scanner;
positioning multiple cameras having sensor arrays within the housing interior to define different a field-of-view for each of said plurality of cameras, the different field-of-views collectively forming a scan field such that one or more target objects cannot pass through said scan field without being imaged by at least one of said cameras;
providing an image processing system in communication with said scanner having memory programmed to identify overlapping areas of said cameras' field-of-views within said scan field;
processing only decoded information from a single target object if the single target object is imaged by more than one camera at substantially the same time in one of said over lapping areas between two or more cameras' field-of-views.

20. The computer readable medium of claim 19 wherein the instructions further comprise the step of processing decoded information for each target object imaged within said scan field at substantially the same time where said target objects are outside of said over lapping areas and wherein at least two of said target objects imaged within said scan field at substantially the same time have identical indicium and data content.
